(19) United States
(12) Patent Application Publication
(10) Pub. No.: US 2014/0017398 A1
(43) Pub. Date: Jan. 16, 2014

(54) MANUFACTURING METHOD OF LIQUID CRYSTAL ALIGNMENT FILM AND LIQUID CRYSTAL ALIGNMENT ELEMENT

(71) Applicant: Chi Mei Corporation, Tainan City (TW)

(72) Inventor: Huai-Pin Hsueh, Tainan City (TW)

(73) Assignee: Chi Mei Corporation, Tainan City (TW)

(21) Appl. No.: 14/028,544

(22) Filed: Sep. 17, 2013

Related U.S. Application Data
(63) Continuation-in-part of application No. 13/373,402, filed on Nov. 14, 2011, now abandoned.
Application No. 13/373,402 is a division of application No. 12/382,098, filed on Mar. 9, 2009, now abandoned.

(30) Foreign Application Priority Data
Mar. 18, 2008 (TW) 097109435
Feb. 12, 2009 (TW) 098104483

(51) Int. Cl. C09K 19/56

(52) U.S. Cl. CPC C09K 19/56
USPC 427/162

(57) ABSTRACT

The present invention provides a free radical polymerizable liquid crystal alignment agent having superior coating ability, a manufacturing method, which comprises the process of coating the liquid crystal alignment agent onto a substrate, and processing the liquid crystal alignment agent with dehydration/ring-closure reaction and free radical polymerization, enables obtaining a liquid crystal alignment film with superior reliability, superior voltage holding ratio and easy control of pretilt angle, and enables the manufacture of a liquid crystal display element provided with a liquid crystal alignment film. The free radical polymerizable liquid crystal alignment agent comprises a molecular compound containing at least 2 polymerizable maleamic acid groups and an organic solvent.

### CROSS-REFERENCE TO RELATED APPLICATION

This application is a continuation-in-part application of and claims the priority benefit of U.S. patent application Ser. No. 13/373,402, filed on Nov. 14, 2011. This prior application Ser. No. 13/373,402 is a divisional application of U.S. application Ser. No. 12/382,098, filed on Mar. 9, 2009 and claims the priority benefit of Taiwan application serial no. 097109435, filed on Mar. 18, 2008 and Taiwan application serial no. 098104483, filed on Feb. 12, 2009. The entirety of each of the above-mentioned patent applications is hereby incorporated by reference herein and made a part of this specification.

### BACKGROUND OF THE INVENTION

1. Field of the Invention

The present invention relates to a novel liquid crystal alignment agent and liquid crystal alignment film formed therefore and manufacturing method use the liquid crystal alignment agent to form liquid crystal alignment film thereof, as well as a liquid crystal display element provided with a liquid crystal alignment film. More specifically, the present invention relates to a free radical polymerizable liquid crystal alignment agent having superior coating ability, and a manufacturing method, which comprises the process of coating the liquid crystal alignment agent onto a substrate, and processing the liquid crystal alignment agent with dehydration/ring-closure reaction and free radical polymerization, enables obtaining a liquid crystal alignment film with superior reliability, superior voltage holding ratio and easy control of pretilt angle, and enables the manufacture of a liquid crystal display element provided with a liquid crystal alignment film.

2. Description of the Prior Art

At present, the polymers such as polyamic acid, polyimide, and the like, are used as a liquid crystal alignment agent, after coating onto a substrate having a transparent conducting film, heating and alignment process to form a liquid crystal alignment film for the liquid crystal display element. Finally, two of the substrates coated with alignment film are placed in opposite directions to form a cell gap holding a liquid crystal layer between the two substrates.

Nematic liquid crystal display elements are predominantly used in general liquid crystal display elements, and concrete examples of types of nematic liquid crystal display elements actually used include: (1) a TN (Twisted Nematic) liquid crystal display element, comprising a liquid crystal alignment direction of one side substrate twisted at a 90 degrees angle to a liquid crystal alignment direction of the other side substrate; (2) a STN (Super Twisted Nematic) liquid crystal display element, comprising a liquid crystal alignment direction of one side substrate twisted at an angle greater than 180 degrees to a liquid crystal alignment direction of the other side substrate; and (3) a TFT (Thin Film Transistor) liquid crystal display element which uses a thin film transistor.

The composition of alignment agents of the prior art comprises a polyamic acid and/or a polyimide of low molecular weight in linear polymer form (non-crosslinked structure), and a solvent. The aforementioned linear polyamic acid or polyimide is obtained by a polycondensation reaction between a diamine compound and a tetracarboxylic acid dianhydride compound. Manufacture of the alignment film includes coating the aforementioned alignment agent on a substrate, which then undergoes a high temperature imidization process and a rubbing process to form the alignment film. A Japanese Patent Publication No. 02-287324 discloses using a polyamic acid as a liquid crystal alignment agent, and a Japanese Patent Publication No. 06-082794 discloses using a polyimide as a liquid crystal alignment agent. However, using a polyamic acid as a liquid crystal alignment agent has the shortcoming of poor reliability; and using a polyimide as a liquid crystal alignment agent has the shortcomings of inferior coating ability and the defect of precipitation is occurred easily on the alignment film.

A Japanese Patent Publication No. 2001-122981 discloses using a maleimide compound of monomeric conformation as an alignment agent, wherein a substrate is directly coated with the maleimide compound, which then undergoes an addition polymerization using photo-radiation to form a polyimide alignment film having alignment effectiveness. However, such an alignment agent still has the problems of inferior coating ability and the defect of precipitation is occurred easily on the alignment film.

Furthermore, a Japanese Patent Publication No. 57-102966 discloses using a maleamic acid compound directly applied to an antifouling coating material. A Japanese Patent Publication No. 02-085238 discloses using a maleamic acid compound as a heat-resisting polyimide resin raw material, which can be used to serve as an optical material, used in machine parts, and so on. However, the aforementioned patents do not disclose use of a maleamic acid compound as a liquid crystal alignment agent, and its effectiveness to improve coating ability, control the pretilt angle, and so on, of the alignment agent.

### SUMMARY OF THE PRESENT INVENTION

The present invention provides a free radical polymerizable liquid crystal alignment agent having superior coating ability, and a manufacturing method, which comprises the process of coating the liquid crystal alignment agent onto a substrate, and processing the liquid crystal alignment agent with dehydration/ring-closure reaction and free radical polymerization, enables obtaining a liquid crystal alignment film with superior reliability, superior voltage holding ratio and easy control of pretilt angle, and enables the manufacture of a liquid crystal display element provided with a liquid crystal alignment film.

The free radical polymerizable liquid crystal alignment agent comprises a molecular compound containing at least 2 polymerizable maleamic acid groups (A) and an organic solvent (B).

The molecular compound containing at least 2 polymerizable maleamic acid groups (A) comprises a compound (A-1) represented by the following formula (1):

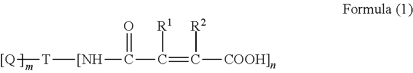

wherein Q is a monovalent organic group; T is a structure selected from an aliphatic, an alicyclic and an aromatic hydrocarbon group; R¹ and R² are hydrogen atoms or alkyl groups having 1 to 8 carbon atoms and may be the same or different; in is an integer of 1 or more; and n is an integer of 2 or more.

The present invention further provides a method of forming a liquid crystal alignment film comprising the process of coating the aforementioned liquid crystal alignment agent onto a substrate, and processing the liquid crystal alignment agent with dehydration/ring-closure reaction and free radical polymerization.

The present invention provides a liquid crystal alignment film comprises a crosslinked structure represented by the following Formula (X):

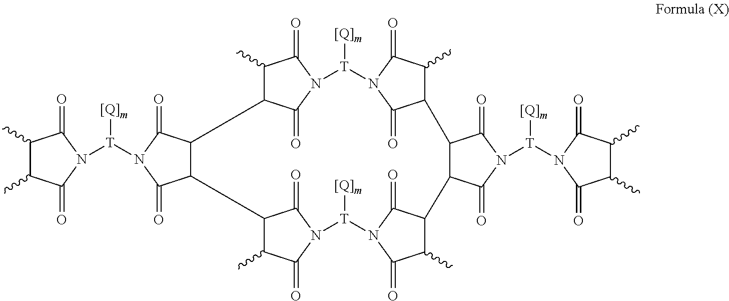

wherein T is a structure selected from an aliphatic hydrocarbon group, an alicyclic hydrocarbon group and an aromatic hydrocarbon group; m is an integer of 1 or more; Q comprises a functional group represented by the following Formula (2):

R³-L- Formula (2)

wherein L is a divalent organic group selected from the group consisting of single bond, —O—, —CO—, —COO—, —OCO—, —NHCO—, —CONH—, —S—, methylene group, alkylene group having 2 to 6 carbon atoms and phenylene group; and R³ is a monovalent organic group selected from the group consisting of a steroid skeleton, an alkyl group having 6 to 30 carbon atoms, an alicyclic or aromatic or a heterocyclic ring skeleton having 4 to 40 carbon atoms and a fluoroalkyl group having 6 to 12 carbon atoms.

The liquid crystal display element of the present invention is provided with a liquid crystal alignment film manufactured using the aforementioned free radical polymerizable liquid crystal alignment agent.

The following provides a separate detailed description of each composition and manufacturing method of the present invention:

### Liquid Crystal Alignment Agent:

The free radical polymerizable liquid crystal alignment agent used by the liquid crystal display element of the present invention comprises the molecular compound containing at least 2 polymerizable maleamic acid groups (A) and an organic solvent (B), and may further comprises an additive agent (C).

### The Molecular Compound Containing at Least 2 Polymerizable Maleamic Acid Groups (A):

There are no particular restrictions on the method used to manufacture the molecular compound containing at least 2 polymerizable maleamic acid groups (A) of the present invention, and is generally obtained from a reaction between maleic anhydride derivatives and multiple amino group compounds.

Examples of maleic anhydride derivatives include maleic anhydride, 2,3-dimethylmaleic anhydride, 2-methylmaleic anhydride, 2,3-diethylmaleic anhydride, 2-ethylmaleic anhydride, and the like, among which maleic anhydride is preferred.

Examples of multiple amino group compounds include diamine compounds, triamine compounds, tetraamine compounds, pentaamine compounds, and the like, among which diamine compounds, triamine compounds, and tetraamine compounds are preferred, more preferred is diamine compounds.

The molecular compound containing at least 2 polymerizable maleamic acid groups (A) of the present invention comprises the compound (A-1) represented by the following Formula (1):

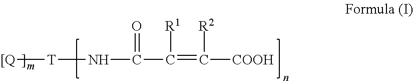

wherein Q is a monovalent organic group; T is a structure selected from an aliphatic, an alicyclic and an aromatic hydrocarbon group; R¹ and R² are hydrogen atoms or alkyl groups having 1 to 8 carbon atoms and may be the same or different; m is an integer of 1 or more; and n is an integer of 2 or more; and wherein Q comprises the functional group represented by the following Formula (2):

R³-L- Formula (2)

wherein L is a divalent organic group selected from the group consisting of single bond, —O—, —CO—, —COO—, —OCO—, —NHCO—, —CONH—, —S—, methylene group, alkylene group having 2 to 6 carbon atoms and phenylene group; and R³ is a monovalent organic group selected from the group consisting of a steroid skeleton, alkyl group having 6 to 30 carbon atoms, alicyclic or aromatic or heterocyclic ring skeleton having 4 to 40 carbons atoms and fluoroalkyl group having 6 to 12 carbon atoms.

A compound obtained from a reaction between maleic anhydride derivatives and diamine compounds is preferred for the compound (A-1) of the present invention, and the structure of the compound (A-1) is represented by the following Formula (3) with the same Q, m, R¹ and R² as defined above:

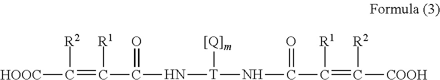

Examples of maleic anhydride derivatives include maleic anhydride, 2,3-dimethylmaleic anhydride, 2-methylmaleic anhydride, 2,3-diethylmaleic anhydride, 2-ethylmaleic anhydride, and the like, among which maleic anhydride is preferred.

Examples of diamine compounds includes compounds represented by Formula (6) and Formula (7).

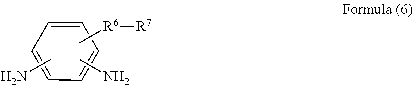

wherein R⁶ is a divalent organic group selected from the group consisting of —O—, —COO—, —OCO—, —NHCO—, —CONH— and —CO—; and R⁷ is a monovalent organic group selected from the group consisting of a steroid skeleton, an alkyl group having 6 to 30 carbon atoms and a fluoroalkyl group having 6 to 12 carbons atoms.

Preferably, the diamine compound represented by Formula (6) is selected from 1-dodecyloxy-2,4-diaminobenzene, 1-hexadecyloxy-2,4-diaminobenzene, 1-octadecyloxy-2,4-diaminobenzene and Formula (6-1)˜Formula (6-8).

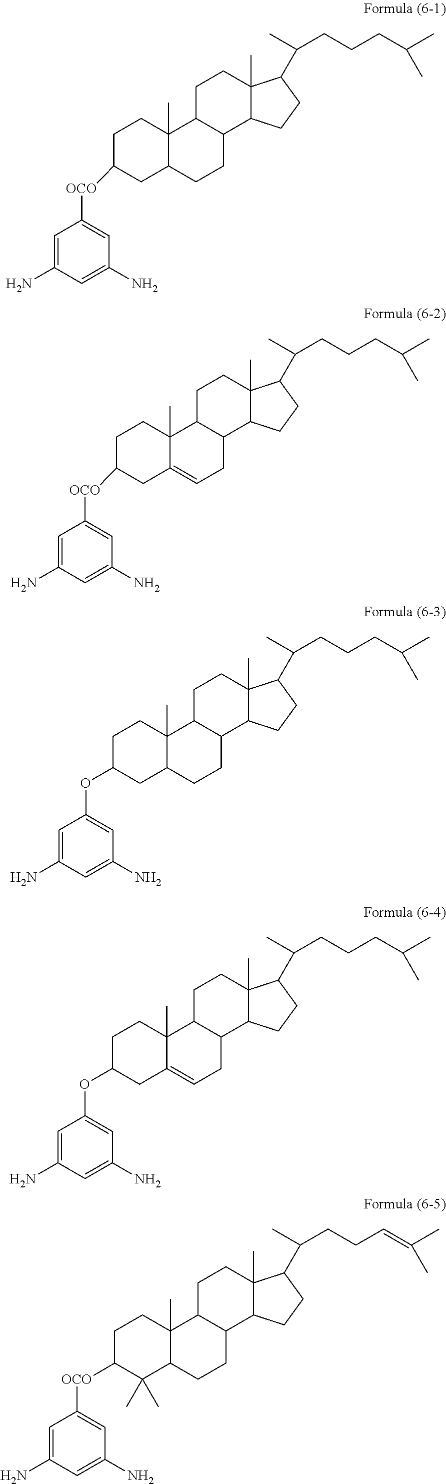

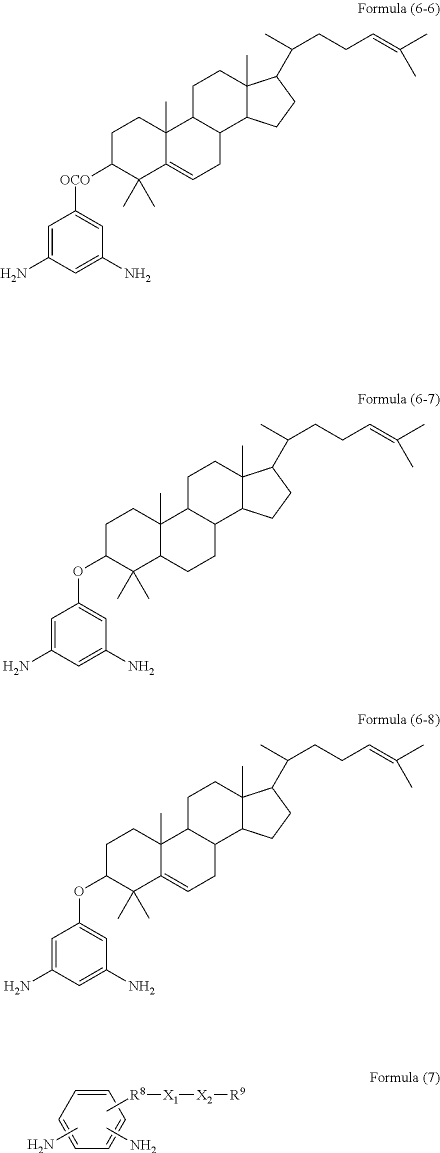

wherein R⁸ is a divalent organic group selected from the group consisting of —O—, —COO—, —OCO—, —NHCO—, —CONH— and —CO—; X₁ and X₂ are having the structure selected from alicyclic, aromatic and heterocyclic ring skeleton; and R⁹ is a monovalent organic group selected from the group consisting of an alkyl group having 3 to 18 carbon atoms, an alkoxy group having 3 to 18 carbon atoms, a fluoroalkyl group having 1 to 5 carbon atoms, a fluoroalkoxy group having 1 to 5 carbon atoms, a cyano group and halogen atoms.

Preferably, the diamine compound represented by Formula (7) is selected from Formula (7-1)˜Formula (7-18).

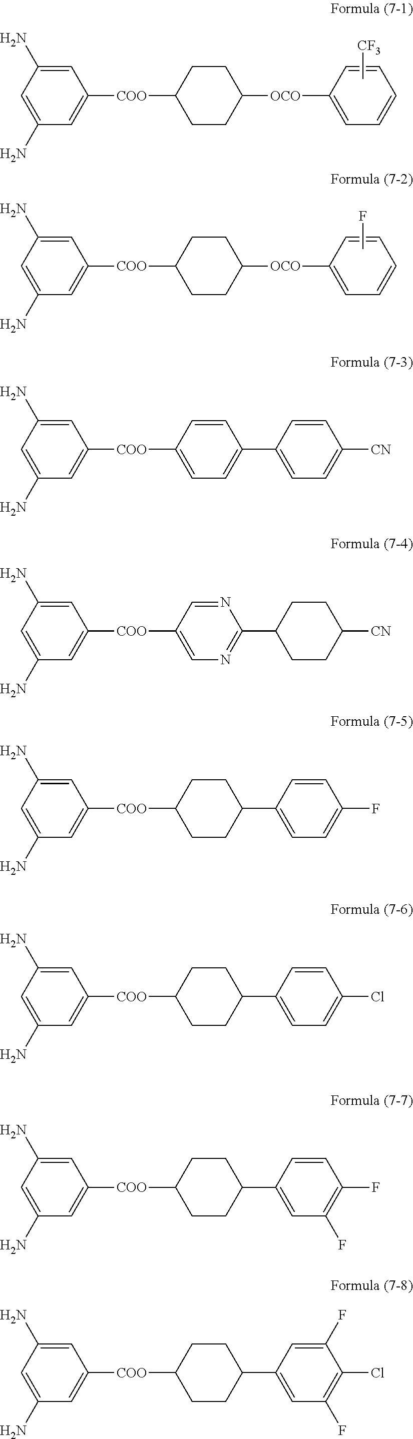

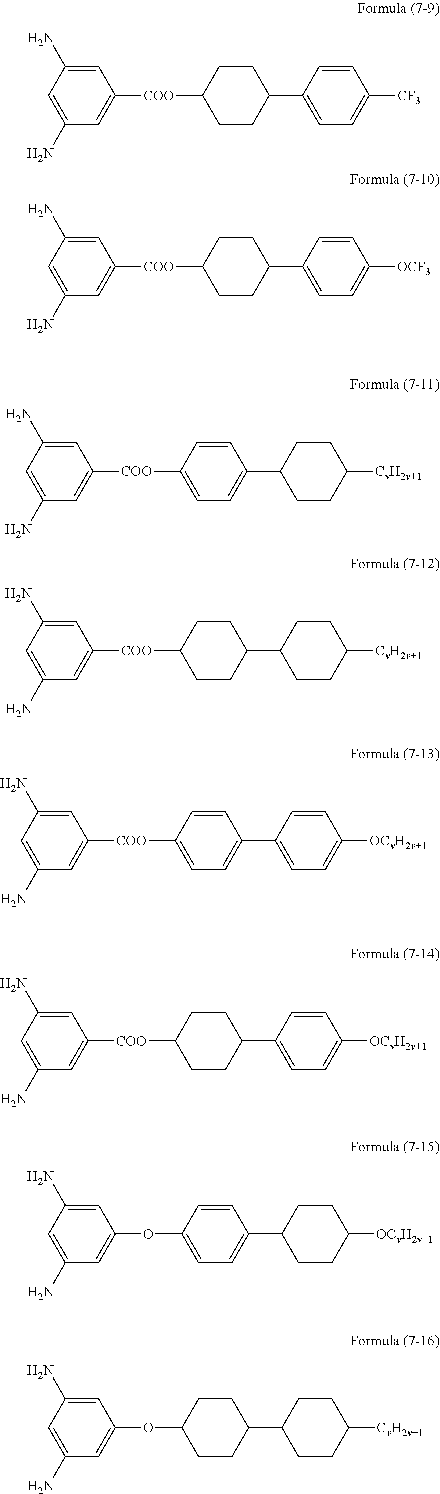

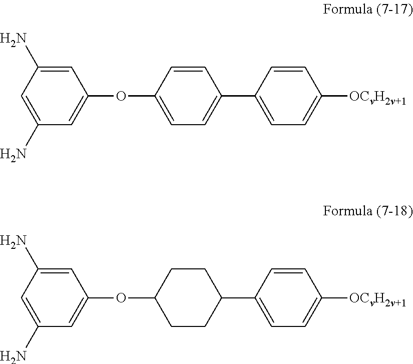

In the above formulas, v is an integer of 3 to 12.

These diamine compounds may be used alone or in admixture of two or more.

In addition to the aforementioned compound (A-1), the molecular compound containing at least 2 polymerizable maleamic acid groups (A) can further comprise a compound (A-2) according to needs. The compound (A-2) comprises the compound represented by the following Formula (4);

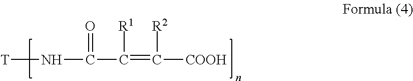

wherein T is a structure selected from an aliphatic, an alicyclic and an aromatic hydrocarbon group; R¹ and R² are hydrogen atoms or alkyl groups having 1 to 8 carbon atoms and may be the same or different; and n is an integer of 2 or more.

A compound obtained from a reaction between maleic anhydride derivatives and diamine compounds is preferred for the compound (A-2) of the present invention, and the structure of the compound (A-2) is represented by the following Formula (5);

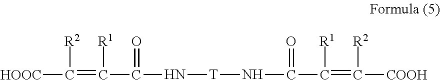

Examples of maleic anhydride derivatives used for the preparation of the compound (A-2) may be the same as the maleic anhydride derivatives used for the preparation of the aforementioned compound (A-1).

Examples of diamine compounds of the present invention include aromatic diamines such as p-phenylenediamine, m-phenylenediamine, o-phenylenediamine, 2,4-diaminotoluene, 1,4-diamino-2-methoxybenzene, 2,5-diaminoxylene, 1,3-diamino-4-chlorobenzene, 1,4-diamino-2,5-dichlorobenzene, 1,4-diamino-3-isopropylbenzene, 4,4′-diaminodiphenyl-2,2′-propane, 4,4′-diaminodiphenylmethane, 4,4′-diaminodiphenylethane, 4,4′-diaminodiphenylsulfide, 4,4′-diaminodiphenylsulfone, 3,3′-diaminodiphenylsulfone, 3,3′-dimethyl-4,4′-diaminobiphenyl, 3,3′-diethyl-4,4′-diaminobiphenyl, 4,4′-diaminobenzanilide, 4,4′-diaminodiphenylether, bis(4-aminophenyl)methylphosphine oxide, bis(3-aminophenyl)sulfoxide, bis(4-aminophenyl)phenylphosphine oxide, bis(4-aminophenyl)cyclohexylphosphine oxide, 4,4′-diaminodiphenylurea, 1,5-diaminonaphthalene, 1,8-diaminonaphthalene, 1,5-diaminoanthraquinone, 2,2′-dimethyl-4,4′-diaminobiphenyl, 5-amino-1-(4′-aminophenyl)-1,3,3-trimethylindane, 6-amino-1-(4′-aminophenyl)-1,3,3-trimethylindane, 3,4′-diaminodiphenylether, 2,2′-diaminobenzophenone, 3,3′-diaminobenzophenone, 3,4′-diaminobenzophenone, 4,4′-diaminobenzophenone, 2,2-bis[4-(4-aminophenoxy)phenyl]propane, 2,2-bis[4-(4-aminophenoxy)phenyl]hexafluoropropane, 2,2-bis(4-aminophenyl)hexafluoropropane, 2,2-bis[4-(4-aminophenoxy)phenyl]sulfone, 4,4′-bis(4-aminophenoxy)biphenyl, 1,4-bis(4-aminophenoxy)benzene, 1,3-bis(4-aminophenoxy)benzene, 1,3-bis(3-aminophenoxy)benzene, 9,9-bis(4-aminophenyl)-10-hydroanthracene, 2,7-diaminofluorene, 9,9-bis(4-aminophenyl)fluorene, 4,4′-methylene-bis(2-chloroaniline), 2,2′,5,5′-tetrachloro-4,4′-diaminobiphenyl, 2,2′-dichloro-4,4′-diamino-5,5′-dimethoxybiphenyl, 3,3′-dimethoxy-4,4′-diaminobiphenyl, 3,3′-diethoxy-4,4′-diaminobiphenyl, 4,4′-(p-phenyleneisopropylidene)bisaniline, 4,4′-(phenyleneisopropylidene)bisaniline, 2,2′-bis[4-(4-amino-2-trifluoromethylphenoxy)phenyl]hexafluoropropane, 4,4′-diamino-2,2′-bis(trifluoromethane)biphenyl, 4,4′-bis[(4-amino-2-trifluoromethyl)phenoxy]-octafluorobiphenyl, and the like; aliphatic and alicyclic diamines such as 1,2-diaminoethane, 1,3-diaminopropane, 1,4-diaminobutane, 1,5-diaminopentane, 1,6-diaminohexane, 1,7-diaminoheptane, 1,8-diaminooctane, 1,9-diaminononane, 1,10-diaminodecane, 1,3-diamino-2,2-dimethylpropane, 1,6-diamino-2,5-dimethylhexane, 1,7-diamino-2,5-dimethylheptane, 1,7-diamino-4,4-dimethylheptane, 1,7-diamino-3-methylheptane, 1,9-diamino-5-methylnonane, 2,11-diaminododecane, 1,12-diaminooctadecane, 1,2-bis(3-aminopropoxy)ethane, 4,4-diaminoheptamethylenediamine, 4,4′-diaminodicyclohexylmethane, 4,4′-diamino-3,3′-dimethyldicyclohexylamine, 1,3-diaminocyclohexane, 1,4-diaminocyclohexane, isophoronediamine, tetrahydrodicyclopentadienylenediamine, hexahydro-4,7-methanoindanylenedimethylenediamine, tricyclo[6.2.1.0^{2,7}]-undecylenedimethylenediamine, 4,4′-methylenebis(cyclohexylamine), and the like; diamines having two primary amino groups and a nitrogen atom other than the primary amino group in the molecule such as 2,3-diaminopyridine, 2,6-diaminopyridine, 3,4-diaminopyridine, 2,4-diaminopyrimidine, 5,6-diamino-2,3-dicyanopyrazine, 5,6-diamino-2,4-dihydroxypyrimidine, 2,4-diamino-1,3,5-triazine, 2,4-diamino-6-dimethylamino-1,3,5-triazine, 1,4-bis(3-aminopropyl)piperazine, 2,4-diamino-6-isopropoxy-1,3,5-triazine, 2,4-diamino-6-methoxy-1,3,5-triazine, 2,4-diamino-6-phenyl-1,3,5-triazine, 2,4-diamino-6-methyl-s-triazine, 4,6-diamino-2-vinyl-s-triazine, 2,7-diaminodibenzofuran, 2,7-diaminocarbazole, 3,7-diaminophenothiazine, 2,5-diamino-1,3,4-thiadiazole, 2,4-diamino-5-phenylthiazole, 2,6-diaminopurine, 5,6-diamino-1,3-dimethyluracil, 3,5-diamino-1,2,4-triazole, 6,9-diamino-2-ethoxyacridine lactate, 3,8-diamino-6-phenylphenanthridine, 1,4-diaminopiperazine, 3,6-diaminoacridine, bis(4-aminophenyl)phenylamine and the like; diaminoorganosiloxanes represented by the following Formula (8); the compounds represented by the following Formula (9)˜Formula (11) and the compounds represented by the following Formula (12)˜Formula (16).

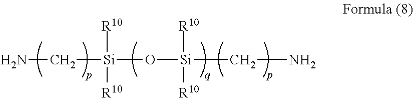

wherein R¹⁰ is a hydrocarbon group having 1 to 12 carbon atoms, with the proviso that a plurality of R¹⁰'s may be the same or different; p is an integer of 1 to 3; and q is an integer of 1 to 20.

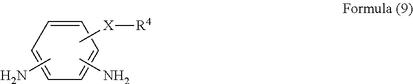

wherein R⁴ is a monovalent organic group having a ring structure containing a nitrogen atom selected from the group consisting of pyridine, pyrimidine, triazine, piperidine and piperazine; and X is a divalent organic group.

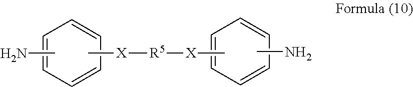

wherein R⁵ is a divalent organic group having a ring structure containing a nitrogen atom selected from the group consisting of pyridine, pyrimidine, triazine, piperidine and piperazine; and X is a divalent organic group with the proviso that a plurality of X's may be the same or different.

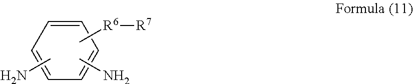

wherein R⁶ is a divalent organic group selected from the group consisting of —O—, —COO—, —OCO—, —NHCO—, —CONH— and —CO—; and R⁷ is a monovalent organic group having a trifluoromethyl group or a fluoro group.

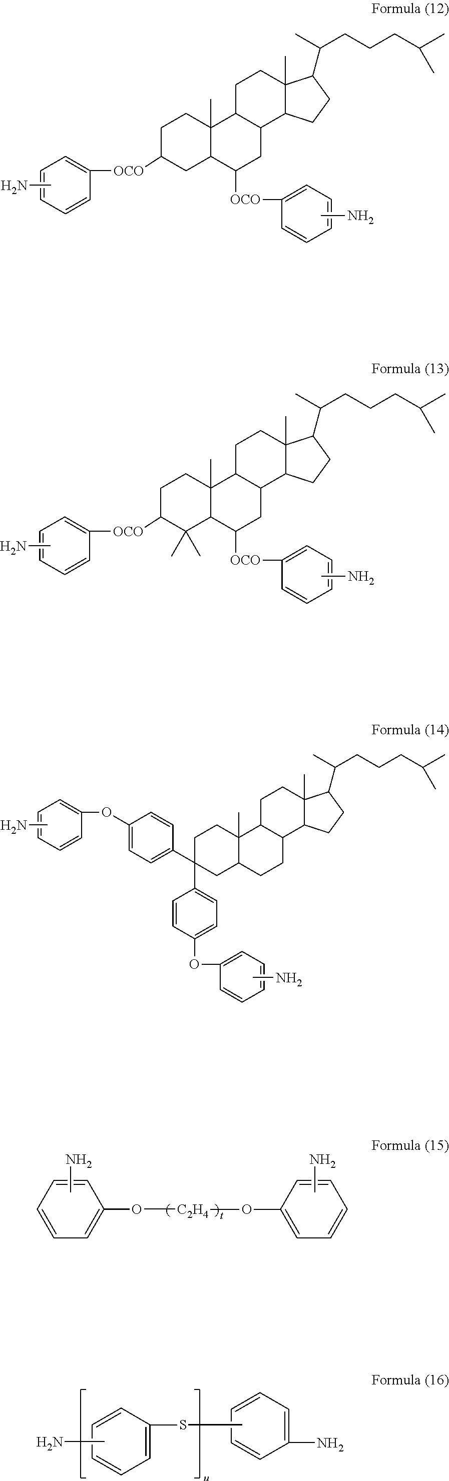

In the above Formulas, t is an integer of 2 to 12, and u is an integer of 1 to 5.

These diamine compounds may be used alone or in admixture of two or more.

The molecular compound containing at least 2 polymerizable maleamic acid groups (A) of the present invention is based on a total of 100 parts by weight of the compound (A-1) and (A-2) therein. The amount of the compound (A-1) used is preferably 0.5˜100 parts by weight, more preferably 2˜100 parts by weight, and the most preferably 2˜60 parts by weight; the amount of the compound (A-2) used is preferably 99.5˜0 parts by weight, more preferably 98˜0 parts by weight, and the most preferably 98˜40 parts by weight. If the amount of the compound (A-1) used is 0.5˜100 parts by weight, an excellent pretilt angle is obtained, alignment is good, and the display of liquid crystal display elements is excellent. The pretilt angle range of TN (Twisted Nematic) liquid crystal display elements is preferably 3˜5 degrees; the pretilt angle range of VA (Vertical Alignment) liquid crystal display elements is preferably 88˜90 degrees.

The molecular compound containing at least 2 polymerizable maleamic acid groups (A) of the present invention contains at least 2 polymerizable functional groups, preferably 2˜4 polymerizable functional groups, more preferably 2 polymerizable functional groups. If the molecular compound only contains 1 or no polymerizable functional group, the voltage holding ratio and reliability are poor. The molecular compound containing at least 2 polymerizable maleamic acid groups (A) of the present invention is able to form an alignment film provided with a crosslinked structure.

In the manufacturing method of the molecular compound containing at least 2 polymerizable maleamic acid groups (A) of the present invention, the organic solvent is required to dissolve the reactant, but there are no particular limitations on the type of organic solvent. Examples of solvents of the present invention include N-methyl-2-pyrrolidone, N,N-dimethylacetamide, N,N-dimethylformamide, dimethylsulfoxide, N-methylcaprolactam, γ-butyrolactone, acetone, methyl ethyl ketone, butyl cellosolve, dioxane, tetrahydrofuran, and the like.

### Organic Solvent (B):

The organic solvent of the liquid crystal alignment agent of the present invention can be selected from the solvents used during the manufacturing process of the aforementioned molecular compound containing at least 2 polymerizable maleamic acid groups (A), and is not further described here. Based on 100 parts by weight of the compound (A), the amount of the organic solvent (B) used in the present invention is generally 100˜10,000 parts by weight, preferably 300˜5,000 parts by weight, and more preferably 500˜3,000 parts by weight.

The free radical polymerizable liquid crystal alignment agent of the present invention may contain other copolymerizable monomers in limits that do not impair the targeted physical properties. Examples of copolymerizable monomers include unsaturated monocarboxylic acids, such as acrylic acid, methacrylic acid, 2-methacryloyl oxyethyl succinate monoester, butenoic acid, α-chloroacrylic acid, ethacrylic acid, cinnamic acid, and the like; unsaturated dicarboxylic acids (or its anhydrides), such as maleic acid, maleic anhydride, fumaric acid, itaconic acid, itaconic anhydride, citraconic acid, citraconic anhydride, and the like; unsaturated polycarboxylic acids (or its anhydrides) having at least 3 carboxyl groups in the molecules and the like; vinyl aromatic compounds such as styrene, α-methylstyrene, vinyltoluene, p-chlorostyrene, methoxystyrene, and the like; maleimides, such as N-phenylmaleimide, N-o-hydroxyphenylmaleimide, N-m-hydroxyphenylmaleimide, N-ρ-hydroxyphenylmaleimide, N-o-methylphenylmaleimide, N-m-methylphenylmaleimide, N-ρ-methylphenylmaleimide, N-o-methoxyphenylmaleimide, N-m-methoxyphenylmaleimide, N-ρ-methoxyphenylmaleimide, N-cyclohexylmaleimide, and the like; unsaturated carboxylates, such as methyl acrylate, methyl methacrylate, ethyl acrylate, ethyl methacrylate, n-propyl acrylate, n-propyl methacrylate, iso-propyl acrylate, iso-propyl methacrylate, n-butyl acrylate, n-butyl methacrylate, iso-butyl acrylate, iso-butyl methacrylate, sec-butyl acrylate, sec-butyl methacrylate, tert-butyl acrylate, tert-butyl methacrylate, 2-hydroxyethyl acrylate, 2-hydroxyethyl methacrylate, 2-hydroxypropyl acrylate, 2-hydroxypropyl methacrylate, 3-hydroxypropyl acrylate, 3-hydroxypropyl methacrylate, 2-hydroxybutyl acrylate, 2-hydroxybutyl methacrylate, 3-hydroxybutyl acrylate, 3-hydroxybutyl methacrylate, 4-hydroxybutyl acrylate, 4-hydroxybutyl methacrylate, allyl acrylate, allyl methacrylate, benzyl acrylate, benzyl methacrylate, phenyl acrylate, phenyl methacrylate, methoxy triethylene glycol acrylate, methoxy triethylene glycol methacrylate, lauryl methacrylate, tetradecyl methacrylate, cetyl methacrylate, octadecyl methacrylate, eicosyl methacrylate, docosyl methacrylate, and the like; unsaturated amino alkyl carboxylates, such as N,N-dimethylaminoethyl acrylate, N,N-dimethylaminoethyl methacrylate, N,N-diethylaminopropyl acrylate, N,N-dimethylaminopropyl methacrylate, N,N-dibutylaminopropyl acrylate, N,t-butylaminoethyl methacrylate, and the like; unsaturated glycidyl carboxylates, such as glycidyl acrylate, glycidyl methacrylate, and the like; vinyl carboxylates, such as vinyl acetate, vinyl propionate, vinyl butyrate, and the like; unsaturated ethers, such as vinyl methyl ether, vinyl ethyl ether, allyl glycidyl ether, methallyl glycidyl ether, and the like; vinyl cyanides, such as acrylonitrile, methacrylonitrile, α-chloroacrylonitrile, vinylidene cyanide, and the like; unsaturated amides, such as acrylamide, methacrylamide, α-chloroacrylamide, N-hydroxyacrylamide, N-hydroxyethyl methacrylamide, and the like; and aliphatic conjugated dienes, such as 1,3-butadiene, iso-propylene, chlorobutadiene, and the like.

### Additive Agents (C):

In addition, the liquid crystal alignment agent of the present invention may contain a functional silane-containing compound or an epoxy compound in limits that do not impair the targeted physical properties in order to improve adhesion to the surface of the substrate. Examples of the functional silane-containing compound include 3-aminopropyltrimethoxysilane, 3-aminopropyltriethoxysilane, 2-aminopropyltrimethoxysilane, 2-aminopropyltriethoxysilane, N-(2-aminoethyl)-3-aminopropyltrimethoxysilane, N-(2-aminoethyl)-3-aminopropylmethyldimethoxysilane, 3-ureidopropyltrimethoxysilane, 3-ureidopropyltriethoxysilane, N-ethoxycarbonyl-3-aminopropyltrimethoxysilane, N-ethoxycarbonyl-3-aminopropyltriethoxysilane, N-triethoxysilylpropyltriethylenetriamine, N-trimethoxysilylpropyltriethylenetriamine, 10-trimethoxysilyl-1,4,7-triazadecane, 10-triethoxysilyl-1,4,7-triazadecane, 9-trimethoxysilyl-3,6-diazanonylacetate, 9-triethoxysilyl-3,6-diazanonylacetate, N-benzyl-3-aminopropyltrimethoxysilane, N-benzyl-3-aminopropyltriethoxysilane, N-phenyl-3-aminopropyltrimethoxysilane, N-phenyl-3-aminopropyltriethoxysilane, N-bis(oxyethylene)-3-aminopropyltrimethoxysilane, N-bis(oxyethylene)-3-aminopropyltriethoxysilane, and the like.

In addition, Examples of the epoxy compound include ethylene glycol diglycidyl ether, polyethylene glycol diglycidyl ether, propylene glycol diglycidyl ether, tripropylene glycol diglycidyl ether, polypropylene glycol diglycidyl ether, neopentyl glycol diglycidyl ether, 1,6-hexanediol diglycidyl ether, glycerin diglycidyl ether, 2,2-dibromoneopentyl glycol diglycidyl ether, 1,3,5,6-tetraglycidyl-2,4-hexanediol, N,N,N′,N′-tetraglycidyl-m-xylenediamine, 1,3-bis(N,N-diglycidylaminomethyl)cyclohexane, N,N,N′,N′-tetraglycidyl-4,4′-diaminodiphenylmethane, 3-(N-allyl-N-glycidyl)aminopropyltrimethoxysilane, 3-(N,N-diglycidyl)aminopropyltrimethoxysilane, and the like.

### Manufacturing Method of the Liquid Crystal Alignment Agent:

The free radical polymerizable liquid crystal alignment agent used by the liquid crystal display element of the present invention comprises the molecular compound containing at least 2 polymerizable maleamic acid groups (A), and the organic solvent (B), and may further comprises the additive agent (C).

In which, in the manufacturing method of the molecular compound containing at least 2 polymerizable maleamic acid groups (A), the proportions of the maleic anhydride derivatives and multiple amino group compounds used are taken from mole fractions of acid anhydride groups of the maleic anhydride derivatives to amino groups of the multiple amino group compounds as standards, and in general is 1.0˜2.5, preferably 1.0˜2.0, and more preferably 1.0˜1.8. The reaction temperature for the maleic anhydride derivatives and the multiple amino group compounds in the organic solvent is generally 0˜100° C., preferably 0˜80° C., and more preferably 0˜70° C. The reaction time is generally 1˜5 hours, preferably 2˜4 hours.

### Manufacturing Method of the Liquid Crystal Alignment Film:

Manufacturing method of the liquid crystal alignment film of the present invention comprises coating the aforementioned free radical polymerizable liquid crystal alignment agent on a substrate, after which dehydration/ring-closure reaction and free radical polymerization are processed to obtain the liquid crystal alignment film.

Manufacturing method of the liquid crystal alignment film comprising a crosslinked structure generally comprises coating at least a mixture of a molecular compound containing at least 2 polymerizable maleamic acid groups (A) and an organic solvent (B) onto a substrate, and then obtaining said crosslinked structure from a free radical polymerization of said molecular compound containing at least 2 polymerizable maleamic acid groups (A).

The liquid crystal alignment agent of the present invention is applied to one side of the substrate having a transparent conductive film by a roller coating method, spinner coating method, printing method, ink-jet method, and the like, after which heat is applied to the coating surface to form a coating film.

Examples of the aforementioned substrate include alkali-free glass, soda-lime glass, Pyrex glass, silica glass, and the like used in liquid crystal display devices; polyethylene terephthalate, polybutylene terephthalate, polyether sulfone, polycarbonate, and the like. The transparent conductive film formed on one side of the substrate is a NESA film (NESA is a registered trademark of PPG Industries, USA) made from tin oxide (SnO₂) or an ITO film made from indium oxide-tin oxide (In₂O₃—SnO₂), and the like.

Before the application of the liquid crystal alignment agent, in order to improve the adhesion of the coating film to the substrate and the transparent conductive film, a functional silane-containing compound or functional titanium-containing compound may be applied to the surface of the substrate.

The heating process to form the alignment film comprises pre-bake and post-bake treatment after coating with the liquid crystal alignment agent, in which the pre-bake causes an organic solvent to volatilize and form a coating film. The temperature of the pre-bake treatment is generally 30˜120° C., preferably 50˜100° C.

Furthermore, after the coating film is formed, the post-bake treatment is carried out, and dehydration/ring-closure reaction (imidization) and free radical polymerization are carried out simultaneously to form the imidized coating alignment film. The temperature of the post-bake treatment is generally 150˜300° C., preferably 180˜280° C., and more preferably 200˜250° C.

During the process of forming the alignment film of the present invention, ultraviolet irradiation can be implemented in advance, and then post-bake is carried out. Moreover, photopolymerization initiators or thermal polymerization initiators can be added to the alignment agent according to needs. The heating process (heat polymerization) is the preferred method for the alignment film processing of the present invention.

The dehydration/ring-closure reactions (imidization) cause maleamic acid groups to form maleimide groups, such as compounds containing maleamic acid groups obtained by reacting diamine compound with maleic anhydride. The reaction can be represented by the following Equation (1):

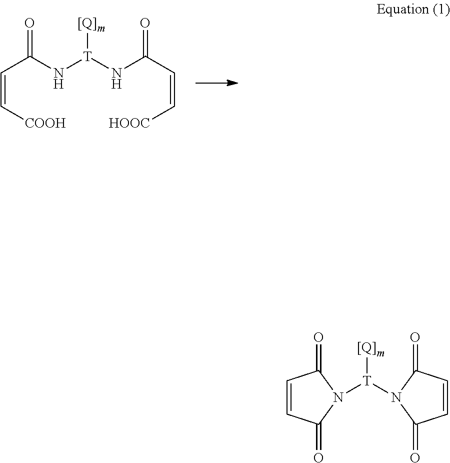

The free radical polymerization causes a polymerization reaction on compounds containing C═C double bonds, such as compounds containing maleimide groups, to form crosslinked structures. The reaction can be represented by the following Equation (2):

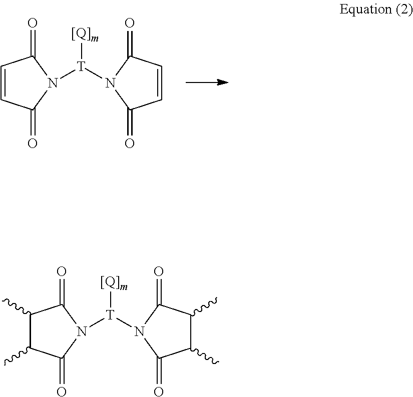

The exemplary imidized alignment film obtained through the dehydration/ring-closure reaction (imidization) and free radical polymerization is the alignment film provided with a crosslinked structure represented by the following Formula (X).

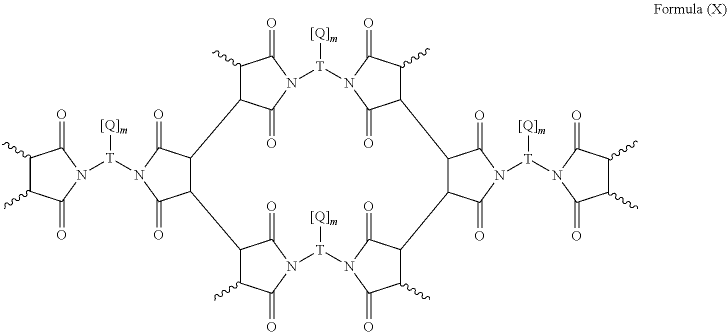

wherein T is a structure selected from an aliphatic hydrocarbon group, an alicyclic hydrocarbon group and an aromatic hydrocarbon group; m is an integer of 1 or more; Q comprises a functional group represented by the following Formula (2):

R³-L- Formula (2)

wherein L is a divalent organic group selected from the group consisting of single bond, —O—, —CO—, —COO—, —OCO—, —NHCO—, —CONH—, —S—, methylene group, alkylene group having 2 to 6 carbon atoms and phenylene group; and R³ is a monovalent organic group selected from the group consisting of a steroid skeleton, an alkyl group having 6 to 30 carbon atoms, an alicyclic or aromatic or a heterocyclic ring skeleton having 4 to 40 carbon atoms and a fluoroalkyl group having 6 to 12 carbon atoms.

An example of an imidized alignment film obtained through the dehydration/ring-closure reaction (imidization) and free radical polymerization is the alignment film provided with a crosslinked structure represented by the following Formula (42).

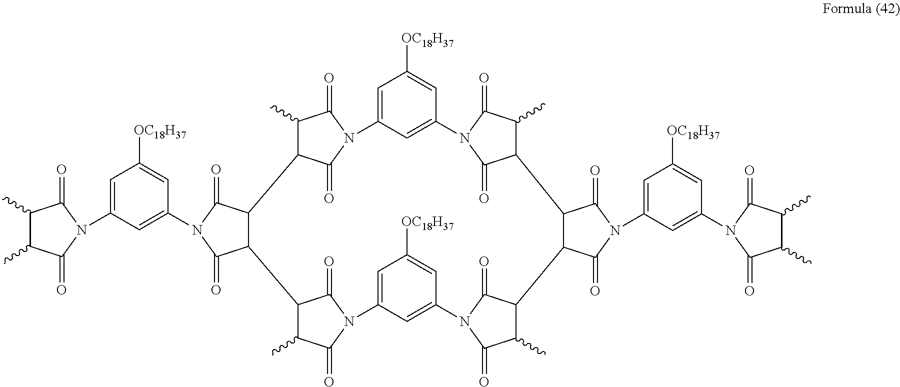

The formed coating film layer is rubbed in a certain direction with a roller wound with nylon, rayon, or cotton fiber cloth according to needs. Thereby, the alignability of the liquid crystal molecules is provided to the coating film to become a liquid crystal alignment film. Moreover, methods that provide the alignability of the liquid crystal molecules with protrusions or patterns formed on at least one substrate are widely known as MVA (Multi-domain Vertical Alignment) or PVA (Patterned Vertical Alignment) methods.

### Manufacturing Method of the Liquid Crystal Display Element:

The liquid crystal display element of the present invention can be manufactured by the method as described below.

Two substrates each having the liquid crystal alignment film formed as the aforementioned manufacturing method of the liquid crystal alignment film are prepared and opposed to each other with a space (cell gap). The peripheral portions of the two substrates are joined together with a sealing agent, liquid crystals are filled into the cell gap defined by the surfaces of the substrates and the sealing agent, and an injection hole is sealed up to form a liquid crystal cell. Then, a polarizer is affixed to the exterior sides of the liquid crystal cell, that is, the other sides of the substrates forming the liquid crystal cell to obtain the liquid crystal display element.

The sealing agent can be used an epoxy resin containing a curing agent, and spacer material can be used glass beads, plastic beads, or photosensitive epoxy resin. Examples of liquid crystals include nematic liquid crystals, such as Schiff base liquid crystals, azoxy liquid crystals, biphenyl liquid crystals, phenylcyclohexane liquid crystals, ester liquid crystals, terphenyl liquid crystals, biphenylcyclohexane liquid crystals, pyrimidine liquid crystals, dioxane liquid crystals, bicyclooctane liquid crystals, cubane liquid crystals, and the like. To the above liquid crystals may be added cholesteric liquid crystals, such as cholesteryl chloride, cholesteryl nonanoate, cholesteryl carbonate, a chiral agent marketed under the trade names of C-15 or CB-15 (products of Merck Company), and the like. In addition, the polarizer affixed to the exterior sides of the liquid crystal cell may be used, for example, a polarizer comprising cellulose acetate protective films sandwiching the polarizing film called “H film” which has absorbed iodine while a polyvinyl alcohol is stretched and aligned, or a polarizer composed of the H film itself.

The present invention will be further illustrated by the following examples.

### BRIEF DESCRIPTION OF THE TABLES

Table 1: Components of Synthesis Examples of alignment agents of the present invention, and

Table 2: Components and evaluation results of Examples of alignment agents of the present invention.

### DETAILED DESCRIPTION OF THE EMBODIMENTS

### Synthesis Examples of Alignment Agents

### Synthesis Example 1

A 500 ml four-necked conical flask equipped with a nitrogen inlet, a stirrer, a heater, a condenser and a thermometer was purged with nitrogen, and the components shown in Table 1 were charged to the flask. The aforementioned components comprising 3.76 g (0.01 moles) of 1-octadecyloxy-2,4-diaminobenzene (hereinafter abbreviated as C18DA), and 50 g of a solvent of tetrahydrofuran (hereinafter abbreviated as THF) were stirred at room temperature until dissolved, after which 2.45 g (0.025 moles) of maleic anhydride (hereinafter abbreviated as MAn) is added and left to react for 3 hours at room temperature. After the reaction was finished, the reaction solution was filtered, and the solid obtained therefore was repeatedly washed using THF and filtered three times, and then placed into a vacuum oven, where drying was carried out at 60° C., thereby obtaining a compound containing 2 maleamic acid groups (A-1-1).

### Synthesis Examples 2-8

The operating procedure of Synthesis Example 1 was repeated, except that the kind of the multiple amino group compound, and the dosage of the maleic anhydride were changed. Details were shown in Table 1.

### Evaluation Method

### (1) Coating Ability:

After coating, the surface of the coating film was viewed using a microscope to check whether there are any coating defects, including pin holes or precipitates.
◯: Surface of the coating film is smooth with no precipitates.
Δ: Surface of the coating film has a few pin holes or a few precipitates.
X: Surface of the coating film has a large number of pin holes or a large number of precipitates.

### (2) Voltage Holding Ratio:

The voltage holding ratio of the liquid crystal cell was measured using an electrical measuring machine (manufactured by TOYO Corporation, Model 6254), with which a 4 volt voltage was applied for 120 microseconds. The applied voltage was held for 16.67 milliseconds, after the applied voltage was cut off for 16.67 milliseconds, the voltage holding ratio was measured and evaluated according to the following standards:
◯: Voltage holding ratio>96%.
Δ: Voltage holding ratio is between 94˜96%.
X: Voltage holding ratio<94%.

### (3) Reliability:

A reliability test was carried out on the liquid crystal cell at a temperature of 70° C. and relative humidity of 80% for 120 hours, and then the method of Evaluation Method (2) was used to measure the voltage holding ratio; the liquid crystal cell was evaluated according to the following standards:
◯: Voltage holding ratio>94%.
Δ: Voltage holding ratio is between 90˜94%.
X: Voltage holding ratio<90%.

### (4) Pretilt Angle:

The pretilt angle was measured by a crystal rotation method using an He—Ne laser light (manufactured by CHUO PRECISION INDUSTRIAL CO., LTD., Model OMS-CM4RD) according to the method described in T. J. Scheffer, et. al., J. Appl. Phys., vol. 19, 2013 (1980).

### Examples and Comparative Examples of A Liquid Crystal Alignment Agent

### Example 1

100 parts by weight of the maleamic acid group compound (A-1-1) obtained from Synthesis Example 1 was dissolved in a cosolvent of 1200 parts by weight of N-methyl-2-pyrrolidone (hereinafter abbreviated as NMP)/300 parts by weight of butyl cellosolve (hereinafter abbreviated as BC) and allowed to completely dissolve at room temperature. The alignment agent solution obtained was coated onto a glass substrate provided with an ITO (indium-tin-oxide) film using a spinner, after which pre-bake was carried out on a hot plate at a temperature of 80° C. for 2 minutes, and post-bake was carried out in an oven at a temperature of 235° C. for 15 minutes. The film thickness was measured to around 750 Å using a film thickness measuring device (manufactured by KLA-Tencor, Model Alpha-step 500). Two glass substrates having the liquid crystal alignment film were manufactured by the aforementioned steps, thermo-compression adhesive agent was applied to one glass substrate, and spacers of 4 μm were sprayed on the other glass substrate. The two glass substrates were bonded together, and after filling with a nematic liquid crystal, then ultraviolet light was used to harden a sealing agent to seal a liquid crystal injection hole, thereby fabricating a liquid crystal cell. The liquid crystal alignment agent and the liquid crystal cell were evaluated with the Evaluation Method as described above, and the results were shown in Table 2.

### Example 2

The operating procedure of Example 1 was repeated, except that the kind and dosage of the maleamic acid group compound (A) were changed. Details and evaluation results were shown in Table 2.

### Example 3

The operating procedure of Example 1 was repeated, except that the kind and dosage of the maleamic acid group compound (A) were changed, and an additive agent (C) was added. Details and evaluation results were shown in Table 2.

### Examples 4˜6

The operating procedure of Example 1 was repeated, except that to perform the alignment process after post-bake, whereby alignment (rubbing) of a surface of the thin film was carried out by using a rubbing machine provided with a roller wound with nylon cloth, a stage moving rate of 35.4 mm/sec, a rotating speed of the roller of 700 rpm, a hair push-in length of 0.5 mm. Moreover, the kind and dosage of the maleamic acid group compound (A) were changed, an additive agent (C) was added, and the dosage of solvent (B) was changed. Details and evaluation results were shown in Table 2.

### Examples 7˜8

The operating procedure of Example 1 was repeated, except that the kind and dosage of the maleamic acid group compound (A), and the dosage of solvent (B) were changed. Details and evaluation results were shown in Table 2.

### Examples 9˜11

The operating procedure of Example 1 was repeated, except that the kind and dosage of the maleamic acid group compound (A), and the dosage of solvent (B) were changed. Details and evaluation results were shown in Table 2.

### Comparative Example 1

A 500 ml four-necked conical flask equipped with a nitrogen inlet, a stirrer, a heater, a condenser and a thermometer was purged with nitrogen, and the components comprising 5 g of the maleamic acid group compound (A-1-1) obtained in Synthesis Example 1 and 50 g of the solvent NMP were charged to the flask. The components were stirred at room temperature until dissolved, after which 5 g of acetic anhydride and 1 g of sodium acetate were added, the temperature was raised to 60° C. and stirring continued for 6 hours. After the reaction was finished, the reaction solution was poured into 500 ml of water to precipitate the compound; the solid obtained after filtering was repeatedly washed using methanol and filtered three times, and then placed into a vacuum oven, where drying was carried out at 60° C., after which the maleimide compound was obtained.

100 parts by weight of the maleimide compound was dissolved in a cosolvent of 1200 parts by weight of NMP/300 parts by weight of BC and allowed to completely dissolve at room temperature. Testing was carried out on the alignment agent solution obtained similar to the operating procedure of Example 1, and the evaluation results obtained were as follows: coating ability: X, voltage holding ratio: ◯, reliability: ◯, pretilt angle: 89.7 degrees.

### Comparative Example 2

A 500 ml four-necked conical flask equipped with a nitrogen inlet, a stirrer, a heater, a condenser and a thermometer was purged with nitrogen, and the components comprising 0.93 g (0.01 moles) of aniline and 50 g of the solvent THF were charged to the flask. The components were stirred at room temperature until dissolved, after which 0.98 g (0.01 moles) of MAn was added and a reaction was allowed to continue for 3 hours at room temperature. After the reaction was finished, the reaction solution was filtered; the solid obtained after filtering was repeatedly washed using THF and filtered three times, and then placed into a vacuum oven, where drying was carried out at 60° C., after which a single maleamic acid group compound was obtained.

100 parts by weight of the single maleamic acid group compound was dissolved in a cosolvent of 1200 parts by weight of NMP/300 parts by weight of BC and allowed to completely dissolve at room temperature. Testing was carried out on the alignment agent solution obtained similar to the operating procedure of Example 4, and the evaluation results obtained were as follows: coating ability: ◯, voltage holding ratio: X, reliability: X, pretilt angle: 0.2 degrees.

### Comparative Example 3

A 500 ml four-necked conical flask equipped with a nitrogen inlet, a stirrer, a heater, a condenser and a thermometer was purged with nitrogen, and the components comprising 1.88 g (0.005 moles) of C18DA, 4.86 g (0.045 moles) of p-phenylenediamine (hereinafter abbreviated as PDA) and 80 g of the solvent NMP were charged to the flask. The components were stirred at room temperature until dissolved, after which 10.9 g (0.05 moles) of pyromellitic dianhydride (hereinafter abbreviated as PMDA) and 20 g of NMP were added and a reaction was allowed to continue for 2 hours at room temperature. After the reaction was finished, the polyamic acid solution was poured into 1500 ml of water to precipitate the polymer. The polymer obtained after filtering was repeatedly washed using methanol and filtered three times, and then placed into a vacuum oven, where drying was carried out at 60° C., after which the polyamic acid polymer was obtained.

100 parts by weight of the aforementioned obtained polyamic acid polymer was dissolved in a cosolvent of 615 parts by weight of NMP/615 parts by weight of BC at room temperature. The alignment agent solution obtained was coated onto a glass substrate provided with an ITO (indium-tin-oxide) film using a spinner, after which pre-bake was carried out on a hot plate at a temperature of 100° C. for 5 minutes, and post-bake was carried out in an oven at a temperature of 220° C. for 30 minutes. The film thickness was measured to around 750 Å using a film thickness measuring device (manufactured by KLA-Tencor, Model Alpha-step 500). An alignment process was carried out on the surface of the thin film, after which the liquid crystal cell was assembled. Testing was carried out on the alignment agent solution obtained, and the evaluation results obtained were as follows: coating ability: ◯, voltage holding ratio: Δ, reliability: Δ, pretilt angle: 4.6 degrees. The voltage holding ratio and reliability were relatively poor.

### Comparative Example 4

A 500 ml four-necked conical flask equipped with a nitrogen inlet, a stirrer, a heater, a condenser and a thermometer was purged with nitrogen, and the components comprising 5.22 g (0.01 moles) of 17-(1,5-dimethylhexyl)-10,13-dimethylperhydrocyclopenta[a]phenanthren-3-yl 3,5-diaminobenzoate (hereinafter abbreviated as HCDA), 4.32 g (0.04 moles) of PDA and 68 g of the solvent NMP were charged to the flask. The temperature was raised to 60° C. and the components were stirred until dissolved, after which 15 g (0.05 moles) of 3,4-dicarboxy-1,2,3,4-tetrahydronaphthalene-1-succinic acid dianhydride (hereinafter abbreviated as TDA) and 30 g of NMP were added and a reaction was allowed to continue for 6 hours at room temperature, thereby a reaction solution of polyamic acid polymer was obtained. 97 g of NMP, 5.61 g of acetic anhydride and 19.75 g of pyridine were further added, the temperature was raised to 60° C. and the contents were stirred continually for 2 hours to carry out imidization. After the reaction was finished, the reaction solution of polyimide polymer was poured into 1500 ml of water to precipitate the polymer. The polymer obtained after filtering was repeatedly washed using methanol and filtered three times, and then placed into a vacuum oven, where drying was carried out at 60° C., after which the polyimide polymer was obtained.

100 parts by weight of the aforementioned obtained polyimide polymer was dissolved in a cosolvent of 615 parts by weight of NMP/615 parts by weight of BC at room temperature. The operating procedure of Comparative Example 3 was repeated, except that the rubbing process was not carried out. Testing was carried out on the alignment agent solution obtained, and the evaluation results were as follows: coating ability: X, voltage holding ratio: ◯, reliability: ◯, pretilt angle: 89.9 degrees.

### Comparative Examples 5˜7

The operating procedure of Example 1 was repeated, except that the kind and dosage of the maleamic acid group compound (A), and the dosage of solvent (B) were changed. In Comparative Example 6, an additive agent (C) was added. Details and evaluation results were shown in Table 2.

While the present invention is illustrated with the preferred embodiments aforementioned, scope of the invention is not thus limited and should be determined in accordance with the appended claims.

TABLE 1
Components of Synthesis Examples of alignment agents

| | | Maleic Anhydride Derivatives | | | | | | | | | | | | | | |
|---|---|---|---|---|---|---|---|---|---|---|---|---|---|---|---|---|
| | | MAn | | MMAn | | Multiple Amino Group Compounds | | | | | | | | | | Mole Ratio |
| | | | Mole | | Mole | C18DA | | HCDA | | PC5E | | DDM | | PDA | | of Acid |
| | | | of Acid | | of Acid | | Mole of | | Mole of | | Mole of | | Mole of | | Mole of | Anhydride |
| Synthesis | | | Anhydride | | Anhydride | | Amino | | Amino | | Amino | | Amino | | Amino | Groups/Amino |
| Examples | | Mole | Groups | Mole | Groups | Mole | Groups | Mole | Groups | Mole | Groups | Mole | Groups | Mole | Groups | Groups |
| 1 | A-1-1 | 0.025 | 0.025 | — | — | 0.01 | 0.02 | — | — | — | — | — | — | — | — | 1.25 |
| 2 | A-1-2 | 0.03 | 0.03 | — | — | — | — | 0.01 | 0.02 | — | — | — | — | — | — | 1.5 |
| 3 | A-1-3 | — | — | 0.02 | 0.02 | — | — | — | — | 0.01 | 0.02 | — | — | — | — | 1 |
| 4 | A-1-4 | 0.02 | 0.02 | 0.01 | 0.01 | — | — | 0.01 | 0.02 | — | — | — | — | — | — | 1.5 |
| 5 | A-1-5 | 0.045 | 0.045 | — | — | 0.01 | 0.02 | — | — | 0.01 | 0.02 | — | — | — | — | 1.125 |
| 6 | A-2-1 | 0.02 | 0.02 | — | — | — | — | — | — | — | — | 0.01 | 0.02 | — | — | 1 |
| 7 | A-2-2 | 0.025 | 0.025 | — | — | — | — | — | — | — | — | — | — | 0.01 | 0.02 | 1.25 |
| 8 | A-2-3 | — | — | 0.04 | 0.04 | — | — | — | — | — | — | 0.01 | 0.02 | 0.01 | 0.02 | 1 |

MAn: maleic anhydride
MMAn: 2-methylmaleic anhydride
C18DA: 1-octadecyloxy-2,4-diaminobenzene
HCDA: 17-(1,5-dimethylhexyl)-10,13-dimethylperhydrocyclopenta[a]phenanthren-3-yl 3,5-diaminobenzoate
PC5E: 3,5-diamino-[4-(trans-4-n-pentylcyclohexyl)phenoxy]benzene
DDM: 4,4′-diaminodiphenylmethane
PDA: p-phenylenediamine

TABLE 2
Components and evaluation results of Examples of alignment agents

| | | | | | | | | | | | | | Comparative | | |
|---|---|---|---|---|---|---|---|---|---|---|---|---|---|---|---|
| | | Examples | | | | | | | | | | | Examples | | |
| Components | | 1 | 2 | 3 | 4 | 5 | 6 | 7 | 8 | 9 | 10 | 11 | 5 | 6 | 7 |
| Maleamic Acid | A-1-1 | 100 | 50 | 15 | 5 | 3 | 1.5 | | | | | | | | |
| Group | A-1-2 | | | | | | | 20 | 10 | | 100 | | | | |
| Compound (A) | A-1-3 | | | | | | | | | 10 | | | | | |
| (parts by weight) | A-1-4 | | | | | | | | | 5 | | | | | |
| | A-1-5 | | | | | | | | | | | 25 | | | |
| | A-2-1 | | 50 | 85 | 95 | 97 | 98.5 | | | 85 | | | 100 | | |
| | A-2-2 | | | | | | | 80 | 90 | | | 5 | | 100 | 50 |
| | A-2-3 | | | | | | | | | | | 70 | | | 50 |
| Organic Solvent (B) | B-1 | 1200 | 1200 | 1200 | 1100 | 1000 | 1300 | 1100 | 1500 | 1200 | 1100 | 1000 | 1200 | 1100 | 1500 |
| (parts by weight) | B-2 | 300 | 300 | 300 | 400 | 500 | 200 | 400 | | 300 | 400 | 500 | 300 | 400 | |
| Additive Agent (C) | C-1 | | | 2 | | | 2 | | | | | | | | |
| (parts by weight) | C-2 | | | | 1 | | | | | | | | | 1 | |
| | C-3 | | | | | 4 | | | | | | | | | |
| Evaluation Results | Coating Ability | ◯ | ◯ | ◯ | ◯ | ◯ | ◯ | ◯ | ◯ | ◯ | ◯ | ◯ | ◯ | ◯ | ◯ |
| | Voltage Holding Ratio (%) | ◯ | ◯ | ◯ | ◯ | ◯ | ◯ | ◯ | ◯ | ◯ | ◯ | ◯ | Δ | Δ | Δ |
| | Reliability | ◯ | ◯ | ◯ | ◯ | ◯ | ◯ | ◯ | ◯ | ◯ | ◯ | ◯ | Δ | Δ | Δ |
| | Pretilt Angle (degrees) | 89.9 | 89.3 | 88.6 | 4.8 | 3.0 | 1.6 | 89.9 | 89.9 | 87.6 | 89.9 | 89.8 | 0.5 | 0.4 | 0.6 |

B-1: N-methyl-2-pyrrolidone
B-2: Butyl cellosolve
C-1: N,N,N′,N′-tetraglycidyl-4,4′-diaminodiphenylmethane
C-2: N,N,N′,N′-tetraglycidyl-m-xylenediamine
C-3: 1,3-bis(N,N-diglycidylaminomethyl)cyclohexane

What is claimed is:

1. A method of forming a liquid crystal alignment film comprising a crosslinked structure represented by the following Formula (X), the method comprising coating at least a mixture of a molecular compound containing at least 2 polymerizable maleamic acid groups (A) and an organic solvent (B) onto a substrate, and then obtaining said crosslinked structure from a free radical polymerization of said molecular compound containing at least 2 polymerizable maleamic acid groups (A): 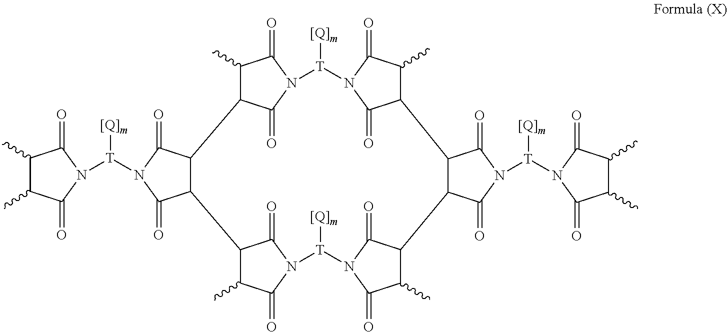
wherein T is a structure selected from an aliphatic hydrocarbon group, an alicyclic hydrocarbon group and an aromatic hydrocarbon group; m is an integer of 1 or more; Q comprises a functional group represented by the following Formula (2):
R³-L- Formula (2)
wherein L is a divalent organic group selected from the group consisting of single bond, —O—, —CO—, —COO—, —OCO—, —NHCO—, —CONH—, —S—, methylene group, alkylene group having 2 to 6 carbon atoms and phenylene group; and R³ is a monovalent organic group selected from the group consisting of a skeleton, an alkyl group having 6 to 30 carbon atoms, an alicyclic or aromatic or a heterocyclic ring skeleton having 4 to 40 carbon atoms and a fluoroalkyl group having 6 to 12 carbon atoms.

2. The method as claimed in claim 1, wherein said free radical polymerization is conducted on the C═C double bonds of maleimide groups of said molecular compound containing at least 2 polymerizable maleamic acid groups (A) formed through dyhydration/ring-closure reactions.

3. The method as claimed in claim 1, wherein said molecular compound containing at least 2 polymerizable maleamic acid groups (A) is obtained from a reaction between maleic anhydride derivatives and multiple amino group compounds.
